(19) United States
(12) Patent Application Publication
(10) Pub. No.: US 2002/0056086 A1
(43) Pub. Date: May 9, 2002

(54) Methods and apparatus for gathering information regarding media user preferences

(76) Inventor: Henry C. Yuen, Pasadena, CA (US)

Correspondence Address: John G. Posa, GIFFORD, KRASS, GROH, SPRINKLE,, PATMORE, ANDERSON & CITKOWSKI, P.C., 280 N. Old Woodward Ave., Suite 400, Birmingham, MI, 48009, US

(21) Appl. No.: 09/783,344

(22) Filed: Feb. 14, 2001

Related U.S. Application Data
(60) Provisional application No. 60/182,389, filed on Feb. 14, 2000.

(51) Int. Cl. H04N 7/16

(52) U.S. Cl. 725/9

(57) ABSTRACT

User interactions with a media distribution system such as cable television are monitored and used to infer programming or commercial preferences, preferably without the user being aware that their interactions are being monitored or used for such purposes. Various user interactions may be recovered in this way, including changes in channel selections, as well as the amount of time a viewer spends, or does not spend, on a particular program or commercial. Information can also be gathered as to when a viewer changes the channel relative to selecting that program, which might be indicative of when that individual has “lost interest” in the program or a commercial message. If the user is interacting with an on-screen program guide, or schedule guide, or other type of menu, information is gathered regarding the interaction such as which entries are selected for further information, which entries are selected for immediate viewing, which entries are selected for future recording. In the preferred embodiment, the information regarding user preferences is delivered to a head end, service providers, advertisers, or other interested parties by way of a two-way cable system. However, the invention may be used in conjunction with return paths such as a modem or internet connection, two-way cable, a dedicated dial-up line, or other operative communication path. In any case, information regarding viewer interactions, whether or not with a program or schedule guide, may be stored locally at the site of the viewer, and transmitted to a different location in a single burst, or communicated on a piecemeal basis when the interactions occur.

### REFERENCE TO RELATED APPLICATIONS

This application claims priority of U.S. provisional patent application Ser. No. 60/182,389, filed Feb. 14, 2000, the entire contents of which are incorporated herein by reference.

### FIELD OF THE INVENTION

This invention relates generally to obtaining information about media user preferences and, in particular, to apparatus and methods for monitoring user interactions such as the amount of time a user spends listening to, or viewing, an audio/video program, menu, or commercial, and inferring user preferences as a function of such interactions.

### BACKGROUND OF THE INVENTION

Television has traditionally been a one-way medium, evolving from on-air broadcasting to include modern cable and, more recently, streaming video over the Internet. Television transmission through a cable network offers a much higher bandwidth, and allows viewers to receive multiple channels as well as audio, games, and information services.

More recently, some cable networks support interactivity, allowing televisions viewers to utilize services such as pay-per-view, video-on-demand, home shopping, interactive games, and home banking. Although these systems require specialized hardware such as more sophisticated head-end servers and set-top boxes to facilitate increased signal bandwidth, they are becoming more commonplace as these enhanced services become more popular.

In an interactive environment, supplemental information is typically transmitted to the viewer in addition to the usual video or audio programming. For example, an interactive environment may include scrolling or pull-down menus operated in conjunction with a pointer device such as a cursor allowing a viewer to make certain selections. These requests are then delivered to the head end or directly to a service provider for fulfillment. As yet, no standard transmission or interaction formats for interactive television have emerged, though various standards are currently under development by television, telephone, or other communications providers.

It is extremely valuable for advertisers to obtain feedback concerning mass media preferences such as the popularity of television shows. With accurate demographic information, and the like, advertisers can better target particular audiences, and increase sales potentials. Many techniques have been devised or proposed for obtaining such information, including the monitoring of broadcast or intermediate frequencies, and the solicitation of viewers in surveys and other rating activities. One problem with at least some of the existing approaches, however, is that the viewer must assume an active role in providing the information or, at the very least, an audience knows it is being monitored, which could affect desired statistics.

### SUMMARY OF THE INVENTION

Broadly according to this invention, user interactions with a media distribution system such as cable television are monitored and used to infer programming or commercial preferences, preferably without the user being aware that their interactions are being monitored or used for such purposes. Various user interactions may be recovered in this way, including changes in channel selections, as well as the amount of time a viewer spends, or does not spend, on a particular program or commercial. Information can also be gathered as to when a viewer changes the channel relative to selecting that program, which might be indicative of when that individual has “lost interest” in the program or a commercial message.

If the user is interacting with an on-screen program guide, or schedule guide, or other type of menu, information is gathered regarding the interaction such as which entries are selected for further information, which entries are selected for immediate viewing, which entries are selected for future recording.

In the preferred embodiment, the information regarding user preferences is delivered to a head end, service providers, advertisers, or other interested parties by way of a two-way cable system. However, the invention may be used in conjunction with return paths such as a modem or internet connection, two-way cable, a dedicated dial-up line, or other operative communication path.

In any case, information regarding viewer interactions, whether or not with a program or schedule guide, may be stored locally at the site of the viewer, and transmitted to a different location in a single burst, or communicated on a piecemeal basis when the interactions occur.

### BRIEF DESCRIPTION OF THE DRAWINGS

FIG. 1 is a diagram showing a prior-art cable television distribution system; and

FIG. 2 is a diagram showing how user preferences may be communicated to interested parties through a feedback path in addition to two-way cable.

### DETAILED DESCRIPTION OF INVENTION

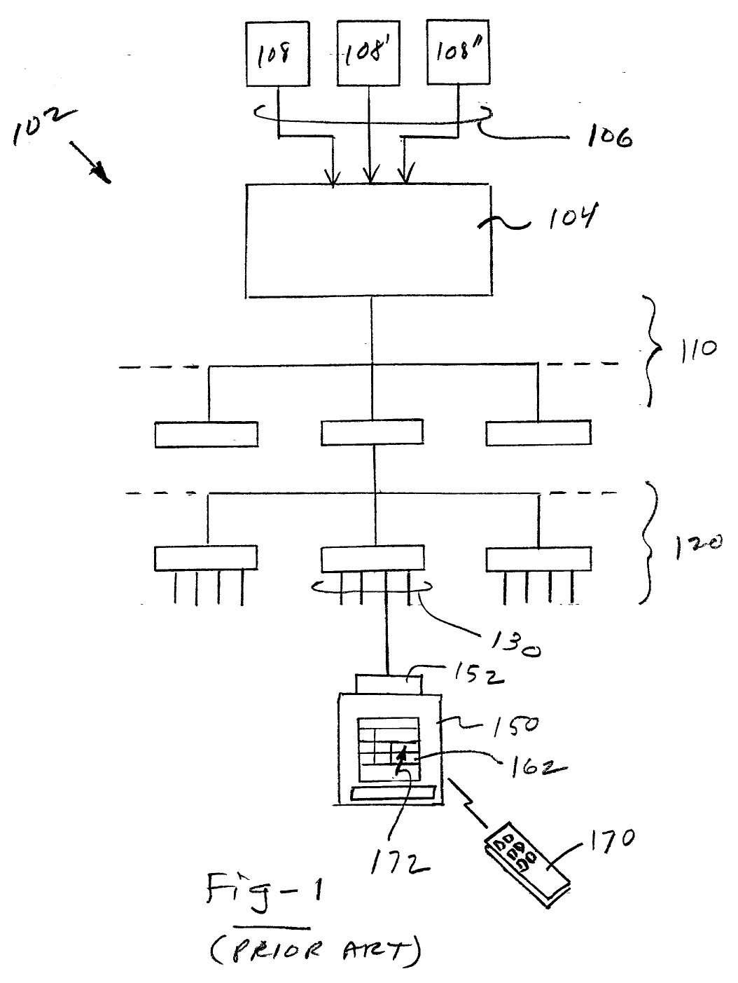

A typical cable television distribution system is depicted in FIG. 1 generally at 102. The network includes a head-end 104, wherein signals 106 from service providers 108, 108′ and 108″ are accumulated. A trunk system 110 carries the signals for distribution to a community, at which point a distribution system 120 takes over to deliver the signals to individual neighborhoods. Subscriber drops 130 provide direct connection to individual television sets such as 150 through a set-top box 152.

The head-end 104 may include a satellite ground station, tape processing, live programming cameras, and equipment for bi-directional interactive services. The trunk system 110 may use off-air broadcasts, fiber-optic lines, coaxial cable, or a combination thereof. The set-top box 152 may include a channels converter, de-scrarnbler, teletext decoder, and so forth. Also visible in FIG. 1 is an electronic program guide 162, enabling a user to interact therewith through an operator control such as hand-held remote 170 to position a pointing device such as cursor 172 on the screen of the display.

This invention takes advantage of technological advances in television distribution of the type just described, as well as viewing modalities to provide automated methods whereby information may be gathered regarding viewer preferences, likes and/or dislikes. Broadly according to this invention, user interactions monitored and used to infer program or commercial preferences, preferably without the user being aware that their interactions are being monitored or used for such purposes. Although the invention will be described in conjunction with a cable network providing an electronic program guide (EPG) capability, it will be appreciated that the invention is readily extensible to other types of delivery systems and non-video programming such as audio listening.

Without the use of a program guide, the invention may monitor channel change operations, how long a viewer watches a particular program or commercial, and so forth. If the user is interacting with an on-screen program guide, or schedule guide, or other type of menu, information is gathered regarding the interaction such as which entries are selected for further information, which entries are selected for immediate viewing, which entries are selected for future recording. In the case of a program guide, such information gathering may be expedited and even limited to the time during which the schedule guide interaction takes place.

Since some electronic program guides, such as those provided through the Gemstar Development Corporation, change channels to provide direct information about selections identified during scrolling, these channel changes may conveniently be used to infer viewer preferences. When using a program schedule guide, the speed with which a user scrolls through the guide may be of interest, in addition to the length of time a person remains on a particular channel, or switches to a new one. In the event that textual information is provided in describing a particular broadcast, the amount of text may be taken into account when assessing how long a viewer spends on a particular program description when scrolling. In any case, the gathered information is preferably passed on to advertisers and other interested parties or entities to facilitate improved user features such as directed programming or user-specific commercials.

In the preferred embodiment, a two-way cable system is used to deliver information regarding the user interactions at least to the head end, if not directly to the service providers or advertisers, for analysis. It may be that information of this kind is sold to such entities given its valuable nature. Regardless of the delivery mechanism, the information regarding user interactivity may be sent as it is gathered, stored at the location of the user and transmitted later, or used exclusively at the user location by filtering or substituting incoming programs or commercials in accordance with inferred preferences.

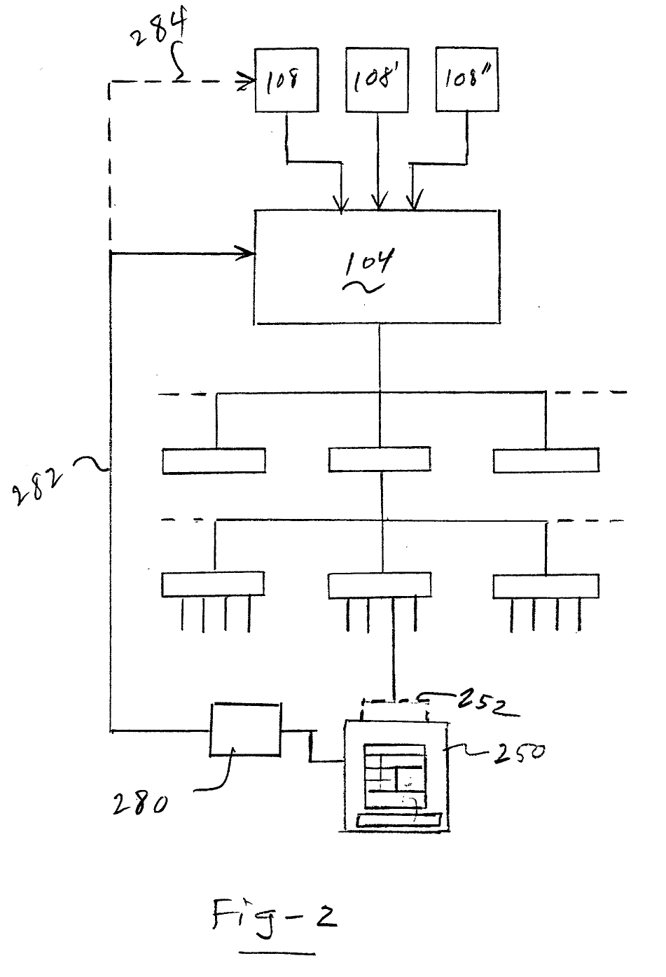

In alternative embodiments, the invention exploits the convergence between television distribution and wide-area computer networks. As shown in FIG. 2, the display unit may be connected to the internet 282 or a dedicated path through a modem 280, thereby enabling a packet-switched return path to communicate patterns in viewer behavior to the head end 104 or directly to advertisers or service providers as depicted by broken path 284.

With regard to embodiments of the invention which take advantage of the convergence of television distribution and wide-area networking, in situations where an environment integrates television reception and an on-line internet connection, for example, as in the case of the current Web-TV® and yet-to-be-developed systems, viewer interactions may be automatically communicated using the appropriate protocol, such as TCP/IP, without the need for a separate set-top box or modem. In further alternative embodiments, user interactions may also be communicated through other return or feedback paths, including two-way pagers.

I claim:

1. In a media delivery system, a method of gathering information regarding user preferences, comprising the steps of:
monitoring a user's interaction with the media delivery system, including the time the user spends listening to, or viewing, a program received through the system;
correlating the subject matter of the program with the amount of time the user spends listening to, or viewing, the program; and
inferring one or more user preferences based upon the correlation.

2. The method of claim 1, wherein the program is an electronic program guide.

3. The method of claim 1, wherein the media delivery system is a cable television system.

4. The method of claim 1, wherein the step of monitoring a user's interaction with the media delivery system occurs through a two-way cable network.

5. The method of claim 1, wherein the step of monitoring a user's interaction with the media delivery system occurs through a packet-switched network.

6. The method of claim 1, wherein the step of monitoring a user's interaction with the media delivery system occurs through a pager signal.

7. The method of claim 1, wherein the step of monitoring a user's interaction with the media delivery system occurs as part of a telephone communication.

8. The method of claim 1, wherein:
the step of correlating the subject matter of the program with the amount of time the user spends listening to, or viewing, the program occurs at the location of the user; and
the step of inferring one or more user preferences based upon the correlation occurs at a location other than the user location.
